(19) United States
(12) Patent Application Publication
(10) Pub. No.: US 2025/0375906 A1
(43) Pub. Date: Dec. 11, 2025

(54) ROBOT ELEMENT WITH ILLUMINATING RING

(71) Applicant: UNIVERSAL ROBOTS A/S, Odense S (DK)

(72) Inventors: Rasmus Borgbjerg NIELSEN, Blommenslyst (DK); Anders Elsøe, Odense C (DK)

(73) Assignee: UNIVERSAL ROBOTS A/S, Odense S (DK)

(21) Appl. No.: 18/876,491

(22) PCT Filed: Jun. 19, 2023
(86) PCT No.: PCT/DK2023/050151

§ 371 Date: Dec. 18, 2024

(30) Foreign Application Priority Data
Jun. 20, 2022 (DK) PA202200587

(51) Int. Cl. B25J 19/00; B25J 9/00; B25J 17/00

(52) U.S. Cl. CPC B25J 19/00; B25J 9/0009; B25J 17/00

(57) ABSTRACT

A robot element for a robot arm where the robot element is connectable to at least another robot element via a connecting flange having a central axis, wherein the robot element comprises: # an annular light source array comprising a plurality of light sources arranged around the central axis and where the plurality of light sources is configured to emit light in a direction along the central axis; # at least one optical component arranged above the light source array and configured to direct at least a part of the light in a direction away from the central axis.

### FIELD OF THE INVENTION

The present invention relates to a robot element for a robot arm comprising a plurality of robot elements such as robot joints and robot links connecting a robot base and a robot tool flange, where the robot element is provided with light sources for providing an illuminating ring around a part of the robot arm.

### BACKGROUND OF THE INVENTION

Robot arms comprising a plurality of robot elements such as robot joints and robot links where motors or actuators can move parts of the robot arm in relation to each other are known in the field of robotics. Typically, the robot arm comprises a robot base which serves as a mounting base for the robot arm and a robot tool flange where to various tools can be attached. A robot controller is configured to control the robot joints in order to move the robot tool flange in relation to the base. For instance, in order to instruct the robot arm to carry out a number of working instructions. The robot joints may be rotational robot joints configured to rotate parts of the robot arm in relation to each other, prismatic joints configured to translate parts of the robot arm in relation to each other and/or any other kind of robot joints configured to move parts of the robot arm in relation to each other.

Typically, the robot controller is configured to control the robot joints based on a dynamic model of the robot arm, where the dynamic model defines a relationship between the forces acting on the robot arm and the resulting accelerations of the robot arm. Often, the dynamic model comprises a kinematic model of the robot arm, knowledge about inertia of the robot arm and other parameters influencing the movements of the robot arm. The kinematic model defines a relationship between the different parts of the robot arm and may comprise information of the robot arm such as, length, size of the joints and links and can for instance be described by Denavit-Hartenberg parameters or like. The dynamic model makes it possible for the controller to determine which torques and/or forces the joint motors or actuators shall provide in order to move the robot joints for instance at specified velocity, acceleration or in order to hold the robot arm in a static posture.

Robot arms need to be programmed by a user or a robot integrator which defines various instructions for the robot arm, such as predefined moving patterns and working instructions such as gripping, waiting, releasing, screwing instructions. The instruction can be based on various sensors or input signals which typically provide a triggering signal used to stop or start at a given instruction. The triggering signals can be provided by various indicators, such as safety curtains, vision systems, position indicators, etc.

Typically, it is possible to attach various end effectors to the robot tool flange or other parts of the robot arm, such as grippers, vacuum grippers, magnetic grippers, screwing machines, welding equipment, dispensing systems, visual systems etc.

Robot systems can also comprise light indicating devices which can indicate the status of the robot system to a user by emitting light. It is difficult to provide indicating light that can be seen by a user from all positions around the robot arm.

US 2019/0299420 discloses a robot system which includes: a robot; a controller controlling the robot and causing the robot to operate in a plurality of operation modes; and a display device attached on the robot and caused by the controller to operate in patterns in accordance with the operation modes, the patterns being different from one another. The display device includes: a sheet-like base part being deformable in a shape in accordance with an outer surface of the robot and having flexibility; one or more display parts fixed on the base part; and a fixture maintaining the base part in a state in which the base part is attached on the outer surface of the robot. The display device according to US 2019/0299420 are difficult to mount in a fast, easy and secure way to a robot arm.

### SUMMARY OF THE INVENTION

The objective of the present invention is to address the above described limitations with the prior art or other problems of the prior art. This is achieved by a robot element for a robot arm, where the robot element is connectable to at least another robot element via a connecting flange having a central axis, wherein the robot element comprises:
an annular light source array comprising a plurality of light sources arranged around the central axis, where the plurality of light sources is configured to emit light in a direction along the central axis;
at least one optical component arranged above the light source array and configured to direct at least a part of the light in a direction away from the central axis.

This makes it possible to provide indicating light on a robot arm that is integrated into the robot arm in a seamless and aesthetic way, which also can be manufactured in an easy and fast way. This is achieved as the light source array can be firmly mounted on a mounting surface of the robot element and the optical component can then easily and fast be arranged above the light source array. By providing the light sources as an array around the central axis and an optical component directing the light in a direction away from the center axis makes is possible to provide an illuminating ring which can be seen from many positions around the robot arm.

The dependent claims describe possible embodiments of the

method according to the present invention. The advantages and benefits of the present invention are described in the detailed description of the invention

### BRIEF DESCRIPTION OF THE DRAWINGS

FIG. 1 illustrates a prior art robot system comprising a robot arm;

FIGS. 2A-2C illustrate two interconnected robot elements, with one robot element according to an embodiment of the present invention;

FIGS. 3A-3C illustrate two interconnected robot elements, with one robot element according to an embodiment of the present invention;

FIGS. 4A-4C illustrate two interconnected robot elements, with one robot element according to an embodiment of the present invention;

FIGS. 5A and 5B illustrate two interconnected robot elements, with one robot element according to an embodiment of the present invention;

FIGS. 6A-6J illustrate a robot element according to an embodiment of the present invention;

FIGS. 7A-7E and 7G-7I illustrate a robot element according to an embodiment of the present invention;

FIGS. 8A-8C illustrate two interconnected robot elements, with one robot element according to an embodiment of the present invention.

### DETAILED DESCRIPTION OF THE INVENTION

The present invention is described in view of exemplary embodiments only intended to illustrate the principles of the present invention. The skilled person will be able to provide several embodiments within the scope of the claims. Throughout the description, the reference numbers of similar elements providing similar effects have been given the same last two digits. Further it is to be understood that in the case, that an embodiment comprises a plurality of the same features then only some of the features may be labeled by a reference number.

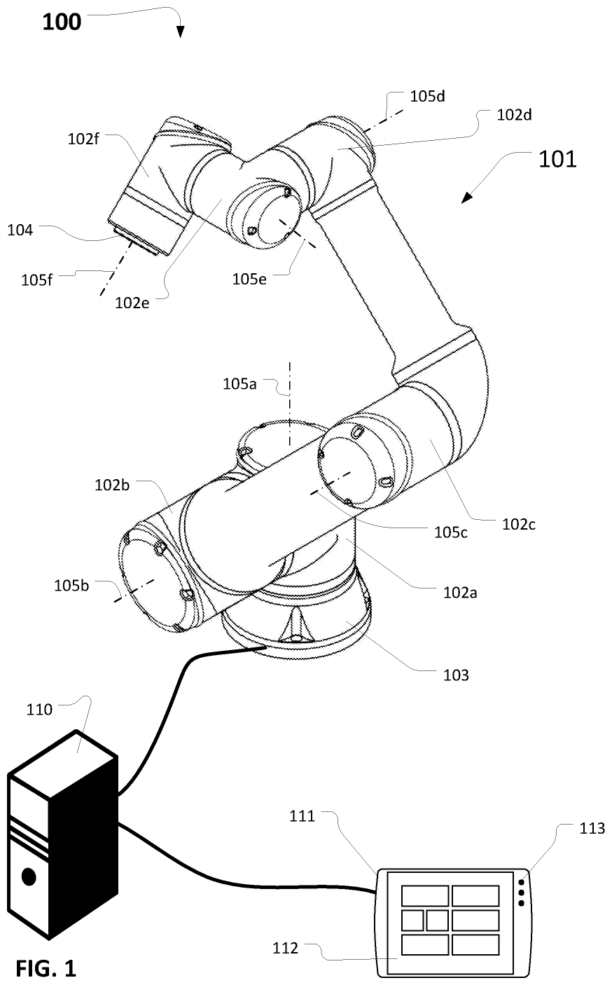

FIG. 1 illustrates a robot system 100 in which the present invention can be utilized. However, the present invention is not illustrated in FIG. 1. The robot system comprises at least one robot arm 101 and at least one robot controller 110 configured to control the robot arm.

The robot arm 101 comprises a plurality of robot joints 102a, 102b, 102c, 102d, 102e, 102f connecting a robot base 103 and a robot tool flange 104. A base joint 102a is configured to rotate the robot arm around a base axis 105a (illustrated by a dashed dotted line); a shoulder joint 102b is configured to rotate the robot arm around a shoulder axis 105b (illustrated by a dashed dotted line); an elbow joint 102c is configured to rotate the robot arm around an elbow axis 105c (illustrated by a dashed dotted line); a first wrist joint 102d is configured to rotate the robot arm around a first wrist axis 105d (illustrated by a dashed dotted line) and a second wrist joint 102e is configured to rotate the robot arm around a second wrist axis 105e (illustrated by a dashed dotted line). Robot joint 102f is a robot tool joint comprising the robot tool flange 104, which is rotatable around a tool axis 105f (illustrated by a dashed dotted line). The illustrated robot arm is thus a six-axis robot arm with six degrees of freedom with six rotational robot joints, however it is noticed that the present invention can be utilized in robot arms comprising less or more robot joints and also other types of robot joints such as prismatic robot joints providing a translation of parts of the robot arm for instance a linear translation.

The robot joints may comprise a robot joint housing and an output flange rotatable or translatable in relation to the robot joint housing and the output flange is connected to a neighbor robot joint either directly or via an arm section as known in the art. The robot joint comprises a joint motor configured to rotate or translate the output flange in relation to the robot joint housing, for instance via a gearing or directly connected to the motor shaft. The robot joint housing can for instance be formed as an angled joint housing and the joint motor can be arranged inside the joint housing and the output flange can extend out of the joint housing. Additionally, the robot joints can comprise at least one joint sensor providing a sensor signal for instance indicative of at least one of the following parameters: an angular and/or linear position of the output flange, an angular and/or linear position of the motor shaft of the joint motor, a motor current of the joint motor or an external force and/or torque trying to rotate the output flange or motor shaft. For instance, the angular position of the output flange can be indicated by an output encoder such as optical encoders, magnetic encoders which can indicate the angular position of the output flange in relation to the robot joint. Similarly, the angular position of the joint motor shaft can be provided by an input encoder such as optical encoders, magnetic encoders which can indicate the angular position of the motor shaft in relation to the robot joint. It is noted that both output encoders indicating the angular position of the output flange and input encoders indicating the angular position of the motor shaft can be provided, which in embodiments where a gearing have been provided makes it possible to determine a relationship between the input and output side of the gearing.

The robot system comprises at least one robot controller 110 configured to control the robot arm 101. The robot controller is configured to control the motions of the parts of the robot arm and the robot joints for instance by controlling the motor torque provided to the joint motors based on a dynamic model of the robot arm, the direction of gravity acting and the joint sensor signal. Further the robot controller may control the motions of the robot arm based on a robot program stored in a memory of the robot controller. The controller can be provided as an external device as illustrated in FIG. 1 or as a device integrated into the robot arm or as a combination thereof.

The robot controller can comprise an interface device 111 enabling a user to control and program the robot arm. The interface device can for instance be provided as a teach pendent as known from the field of industrial robots which can communicate with the controller via wired or wireless communication protocols. The interface device can for instanced comprise a display 112 and a number of input devices 113 such as buttons, sliders, touchpads, joysticks, track balls, gesture recognition devices, keyboards, microphones etc. The display may be provided as a touch screen acting both as display and input device. The interface device can also be provided as an external device configured to communicate with the robot controller, for instance in form of smart phones, tablets, PCs, laptops etc.

The robot system may also comprise an end effector (not illustrated) attached to the robot tool flange and it is to be understood that the end effector can be any kind of end effector such as grippers, vacuum grippers, magnetic grippers, screwing machines, welding equipment, gluing equipment, dispensing systems, painting equipment, visual systems, cameras etc.

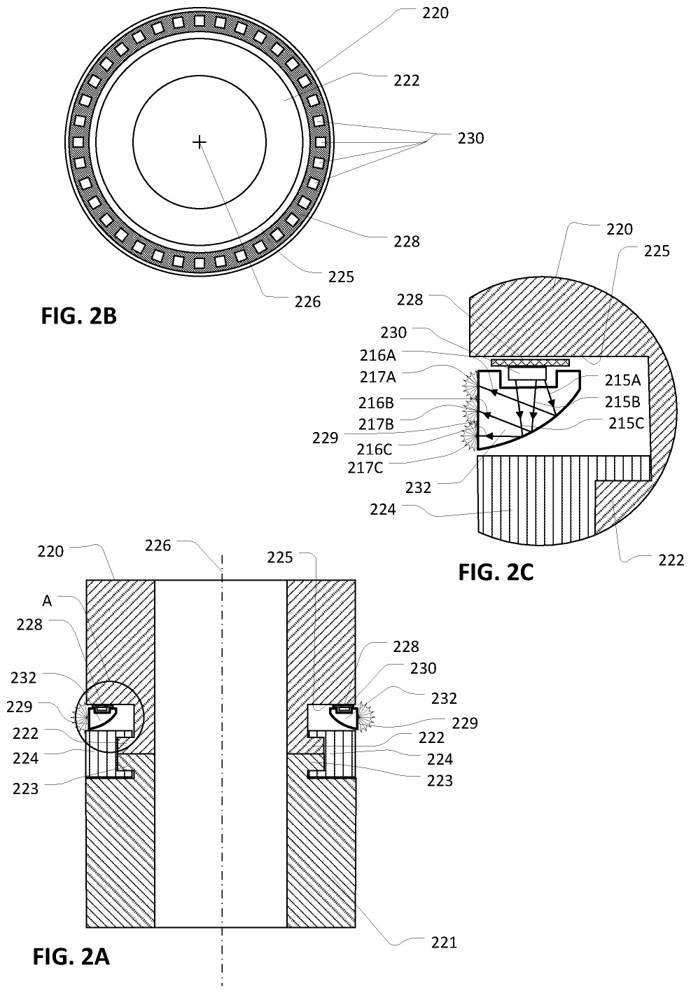

FIGS. 2A-2C illustrate two interconnected robot elements 220, 221 of a robot arm, where one of the robot elements 220 is provided as an embodiment of the robot element according to the present invention. FIG. 2A is a structural cross-sectional view of the two interconnected robot elements 220, 221 and FIG. 2B is a top view of the robot element 220 with the optical component 232 removed and FIG. 2C is an enlarged view of part A of FIG. 2A.

The two robot elements are illustrated as two cylindrical shaped housings with a central opening through the housing. The robot elements can for instance be robot links, robot joints and/or a robot base and it is to be understood that the robot elements also can comprise one or more motors, one or more gears, one or more sensors, and/or one or more controller circuits for controlling components of the robot arm, such as the motors. It is also to be understood that the housing of the robot element can have another shape than cylindrical, for instance the robot element may be an angle joint housing as known in the field of robot arms where the robot joint comprises two connecting flanges which his angled substantially 90 degrees in relation to each other. In the illustrated embodiment a connecting flange 222 of the robot element 220 is connected to another connecting flange 223 of another robot element 221 by a clamp 224. The connecting flanges 222, 223 and the clamp 224 can for instance be provided as any known robot joint assemblies for instance as disclosed in WO 2018/130447 A1 or U.S. Pat. No. 9,505,136B1.

The robot element 220 comprises an annular light source array 228 comprising a plurality of light sources 230 arranged around the central axis, and the plurality of light sources is configured to emit light in a direction along the central axis. In the illustrated embodiments the light sources are LEDs (light emitting diodes), however the skilled person realizes that any kind of light sources can be used, such as, OLEDs (Organic Light Emitting Diodes), PLED's (Polymer Light Emitting Diodes), plasma sources, filament lamps, fluorescent light sources, phosphor based light sources, or other suitable light sources. The light sources 230 may comprise one or more light source units, for example two or more light source units emitting different colors. For example, a light source may be provided as a multi-die LED comprising a plurality of LED dies emitting different colors for instance red, green and blue dies (known as a 3 in 1 RGB LEDs) or may comprise a red, green, blue and white dies (known as a 4 in 1 RGBW LEDs). The robot element may also comprise a light controller configured to control the light sources for instance in order to control the color of emitted light e.g., by utilizing additive color mixing as known in the art of illumination where for instance light of different colors from a multi-die RGBW LED are varied in relation to each other using the well-known method of pulse width modulation. In one embodiment each light source can be controlled individually and can thereby function as a pixel. However, it is to be understood the light sources also can be divided into sub arrays with a plurality of light sources which can be controlled as a group, or all light sources can be controlled as a single group of light sources. In one embodiment the light sources can be provide as multi-die LEDs comprising both a driving circuit and light controller capable of controlling the multi-die LED based on an input signal indicative of for instance color and/or intensity. In the illustrated embodiment the annular light source array is provided as a single annular printed circuit board PCB whereon a plurality of LEDs is arranged.

In an embodiment the inner dimension of the light source array is larger than the cross-section dimension of the connecting flange. This makes it possible to mount the annular light source array onto the robot element in a single step for instance by passing the light source array over the connecting flange, such that the connecting flange passes through an opening of the light source array. The light source array can then be mounted to a mounting surface 225 of the robot element, for instance by glue, screws, rivets, nails, snap mechanism, or other kind of fastening mechanisms. The light source array can thereby be mounted below the connecting flange. However, it is to be understood that the printed circuit board in alternative embodiments also can be provided as a plurality of printed circuit boards each comprising some of the light sources 230.

At least one optical component 232 is arranged above the light source array and the optical component is configured to direct at least a part of the light in a direction away from the central axis. The at least one optical component can be any optical component capable of directing light emitted in a direction along the central axis in a direction away from the central axis.

That the light is emitted along a direction along the central axis mean that the light emitted by the light source is propagating along an axis parallel with the central axis at an angle below 45 degrees in relation to the central axis. Consequently, if the light is propagating along a propagation vector defined in a cartesian coordinate system with a first coordinate axis parallel with the central axis and with a second and third coordinate axis perpendicular to the central axis, then the vector component of the propagation vector of the first coordinate axis is larger than the vector components of the second and third coordinate axis.

That the light is propagating along a direction away from the central axis mean that the light is propagating in a radial direction away from the central axis. For instance, the light can propagate along an axis perpendicular to the central axis at an angle below 45 degrees in relation to the axis perpendicular to the central axis. Consequently, if the light is propagating along a propagation vector defined in a cartesian coordinate system with a first coordinate axis parallel with the central axis and with a second and third coordinate axis perpendicular to the central axis, then the vector component of the propagation vector of the first coordinate axis is smaller than at least one of the vector components of the second and third coordinate axis.

In the illustrated embodiment the optical component is provided as a solid transparent annular ring having an input surface facing towards the light source, a refection surface configured to reflect at least a part of the light towards an output surface forming the outer circumferential surface of the optical component. FIG. 2C illustrates three exemplary light rays where first part of the light rays 215A, 215B, 215C illustrates the light emitted by the light source propagating in a directing along the central axis and a second part of the light rays 216A, 216B, 216C directed in direction away from the central axis by the optical component 232. The first part of the light rays enters the input surface of the optical component and hits the refection surface whereafter the light is redirected in the direction away from the central axis as the second part of the light rays. It is noted that the light rays are provided only to illustrate the principles of the invention and that they do not illustrate exact and precise light rays. The transparent optical component can be provided in any optical transparent material such as glass, polymers, silicone, acrylic materials. In the illustrated embodiment the reflection surface is provided by utilizing the principles of internal reflection of optical components where at least a part of the light hitting an inner surface of the optical component is internally reflected inside the optical component. In one embodiment the curvature of the refection surface can be designed such that most of the light is reflected towards the outputs surface, this can for instance be achieved by utilizing total internal refection. In other embodiments a reflecting coating can be applied to the refection surface. The optical component can also be provided as an annular reflecting surface for instance as a polished metal part configured to reflect the light or provided in another material which is coated with a reflecting coating. The optical component can also be provided as a plurality of optical components receiving light propagating in a direction along the central axis from one or more of the light sources and directing the received light in a direction away from the optical axis.

The optical component can also comprise a diffusing element configured to diffuse the light propagating in a direction away from the central axis in many directions away from the central axis. This makes it possible to observe the illumination from many directions and does also provide an equally distributed illumination. In the illustrated embodiment the optical diffusing element 229 is provided at the output surface of the optical component 232 and each of the second part 216A, 216B, 216C of light rays is diffused in many directions as illustrated by the plurality of arrows illustrating diffused light 217A, 217B, 217C.

In one embodiment the inner dimension of the annular optical component is larger than the cross-section dimension of the connecting flange. This makes it possible to mount the annular optical component onto the robot element in a single step for instance by passing the optical component over the connecting flange, such that the connecting flange passes through an opening of the optical component. The optical component can then be mounted on top of the light source array for instance by glue, screws, rivets, nails, snap mechanism, or other kind of fastening mechanisms. The optical component can thereby be mounted below the connecting flange.

In one embodiment the outer dimension of the annular optical component is substantially the same as the outer cross-sectional dimension of the robot element. In the illustrated embodiment this is achieved by providing the output surface of the optical component with the same diameter as the robot element.

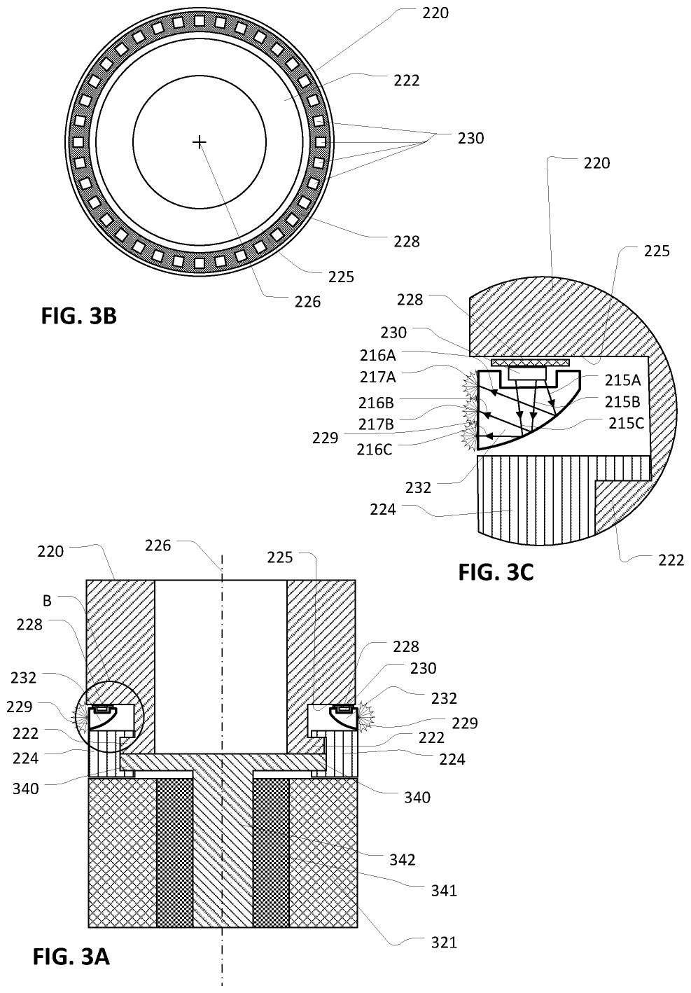

FIGS. 3A-3C illustrate two interconnected robot elements 220, 321 of a robot arm, where one of the robot elements 220 is provided as an embodiment of the robot element according to the present invention. FIG. 3A is a structural cross-sectional view of the two interconnected robot elements 220, 321, FIG. 3B is a top view of the robot element 220 with the optical component 232 removed and FIG. 3C is an enlarged view of part B of FIG. 3A. The illustrated interconnected robot elements 220,321 are to a large extend identical with the interconnected robot elements 220,221 illustrated in FIGS. 2A-2C and identical features have been given the same reference numbers as in FIGS. 2A-2C and with not be described further.

In this embodiment the connection flange 222 of the robot element 220 is configured to interconnect with an output flange 340 of another robot element 321, where the other robot element comprises a motor 341 having a motor axle 342 rotatable around the central axis 226 and the motor axle is connected to the output flange 340.

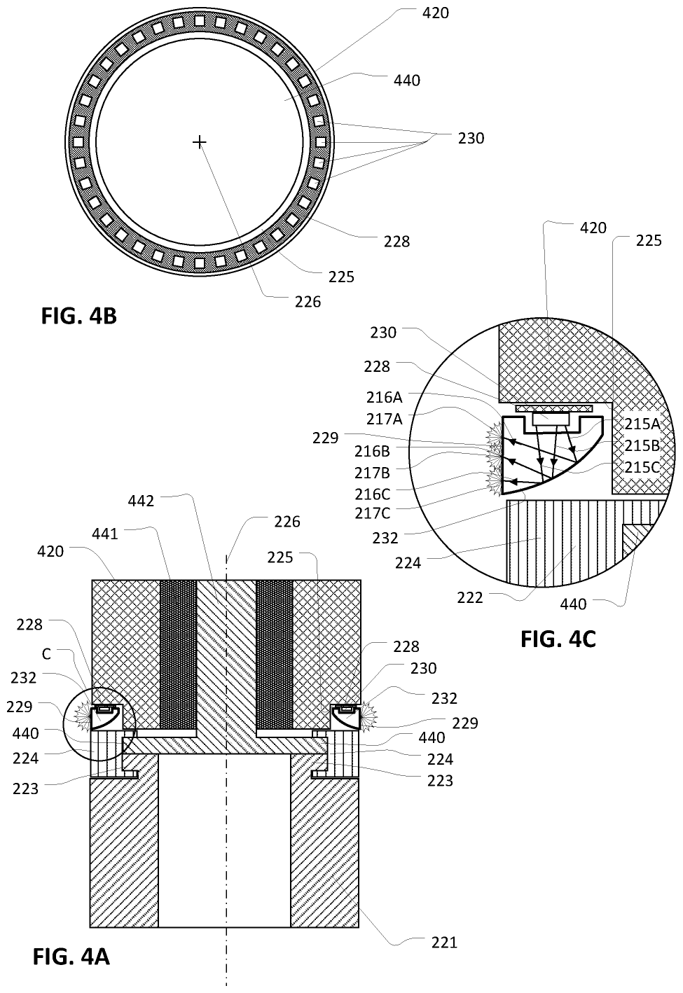

FIGS. 4A-4C illustrates two interconnected robot elements 420, 221 of a robot arm, where one of the robot elements 420 is provided as an embodiment of the robot element according to the present invention. FIG. 4A is a structural cross-sectional view of the two interconnected robot elements 420, 221, FIG. 4B is a top view of the robot element 420 with the optical component 232 removed and FIG. 4C is an enlarged view of part C of FIG. 4A. The illustrated interconnected robot elements 420,221 are to a large extend identical with the interconnected robot elements 220,221 illustrated in FIGS. 2A-2C and identical features have been given the same reference numbers as in FIGS. 2A-2C and with not be described further.

In this embodiment the robot element 420 comprises a motor 441 having a motor axle 442 rotatable around the central axis, wherein the connecting flange is an output flange 440 connected to the motor axle and connected to the other connecting flange 223 of the other robot element 221.

Providing a motor, motor axel and output flange makes as illustrated in FIGS. 3A-3C and 4A-4C it possible to rotate the two robot elements in relation to each other and the present invention makes it possible to provide an illuminating ring around the axis of rotation which is coincidence with the center axis of the light source array. The motor and motor axel can be provided as known in the art of robotics and it is also to be understood that a transmission unit such as a gear can be provided between the motor axel and the output flange.

In one embodiment the annular light source array comprises at least 12 light sources which makes it possible to ensure the light is provided all the way around the center axis of the robot element. Thereby the optical component will appear as an illuminating ring with a substantial equal light distribution around the center axis. In an embodiment with 12 light sources, the light sources can be separated by an angle of 30 degrees. In an embodiment with 24 light sources, the light sources can be separated by an angle of 15 degrees which can ensure that substantial every point of the optical component around the center axis will receive light from a plurality of light sources. In the embodiment illustrated in FIGS. 2A-3B the light source array comprises 36 light sources separated at an angle of 10 degrees; however, it is to be understood that any number more the 12 light sources can be provided.

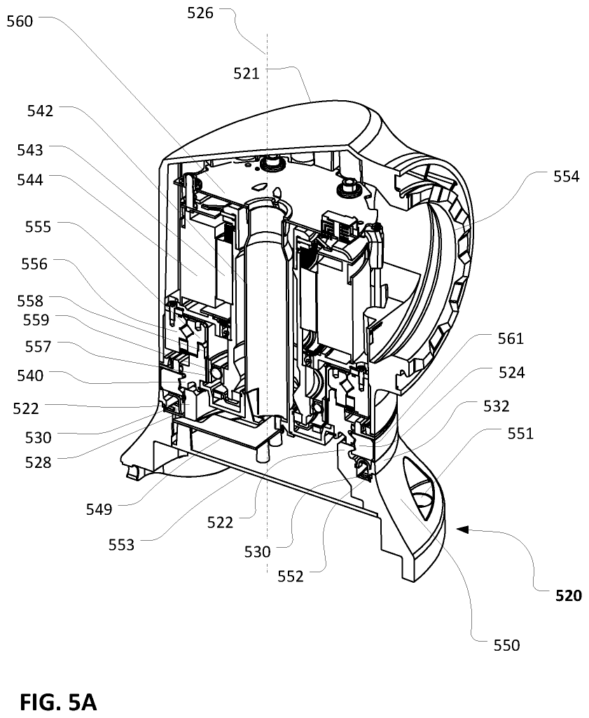

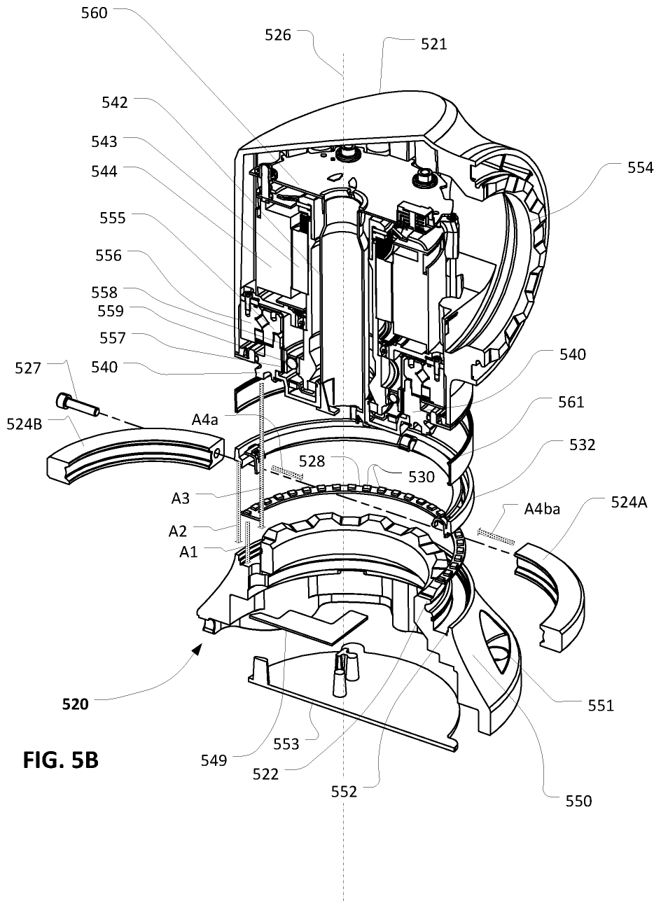

FIGS. 5A and 5b illustrate two interconnected robot elements 520, 521 of a robot arm, where one of the robot elements 520 is provided as an embodiment of the robot element according to the present invention. FIG. 5A is a perspective cut-away view showing the cross-sectional of the two interconnected robot elements 520, 521 in an assembled configuration, and FIG. 5B is a perspective cut-away view showing the cross-sectional of the two interconnected robot elements 520, 521 in a disassembled configuration. In FIG. 5A and 5B components and elements providing similar effects as similar components have been given the same last two digits as in FIGS. 2A-4C and the basic principles describe in the previous figures do also apply to these components.

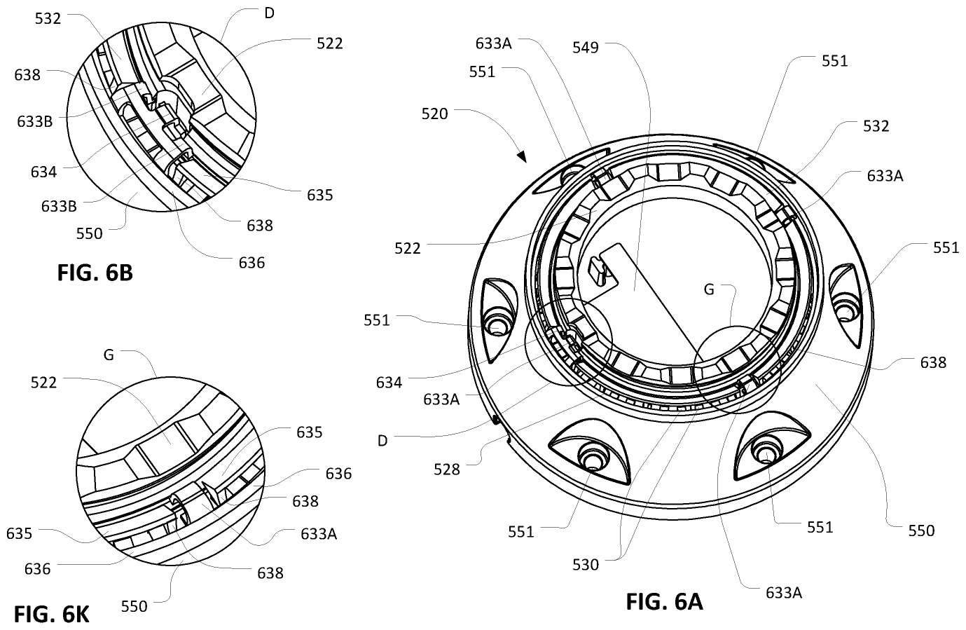

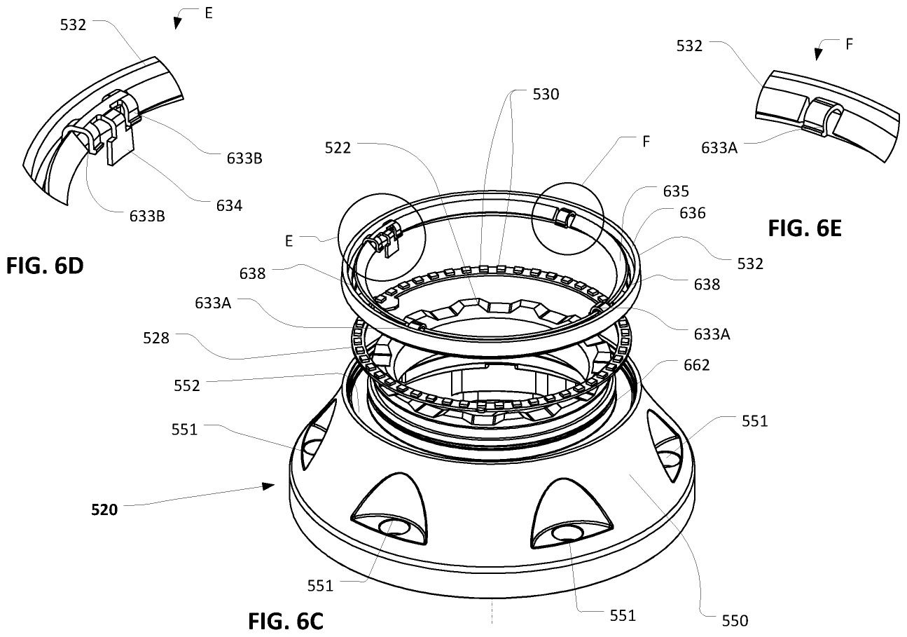

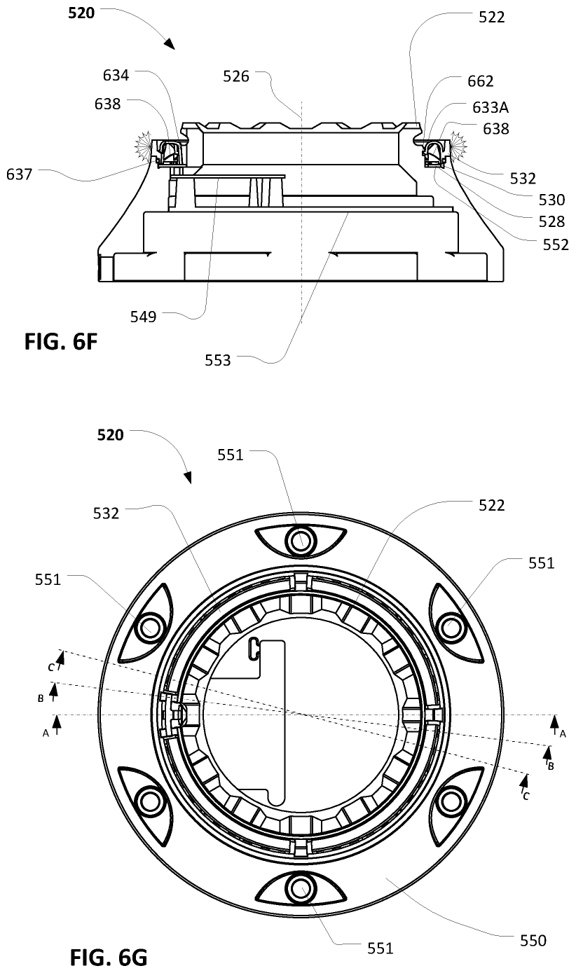

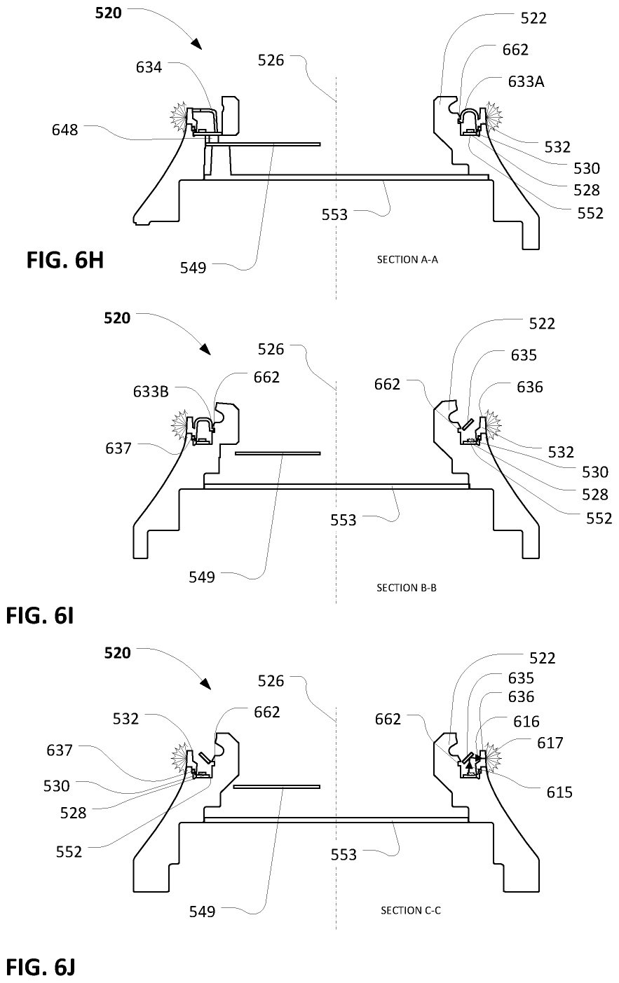

The robot element 520 is a robot base configured to support a robot arm and is provided as a housing formed as a substantially hollow conical cone frustrum 551 with a plurality of screw holes 551 for securing the robot base to a supporting structure such as a table, a floor, a wall, a roof, an AGV (Automated Guided Vehicle) or another structure. The connecting flange 522 is provided as an integral part of a top part of the housing and a mounting recess 552 is formed as an integral part of the housing around and below the connecting flange. A light source array in form of an annular PCB comprising a plurality of LEDs 530 is arranged in the mounting recess and an annular optical component 532 is arranged above the light source array. In the illustrated embodiment the annular PCB comprises 48 LEDs. A bottom cover 553 is provided inside the housing and serve to provide a closed cavity inside the robot base. A light source control PCB 549 comprising circuits for providing power to and/or controlling the light sources is provided in the cavity. Further details of the robot element will be described in connection with FIGS. 6A-6J

The robot element 521 is a robot joint comprising an angled joint housing having an angled connection flange 554 configured to be interconnected with a further robot element such as a further robot joint or robot link. The angled connection flange 554 is provided at an angle of 90 degree in relation to and output flange 540. The output flange 540 is connected to the inner ring 555 of a strain wave gear comprising an outer ring 556 where in the inner ring 555 is rotatably arranged. The inner ring comprises an internally toothed gear 557; a flex spline 558 arranged in the inner ring, the flex spline comprises a flexible part comprising an external toothed gear. A wave generator 559 is arranged in the flex spline and is rotatable in relation to the flex spline and is configured to flex the flexible part in a radial direction to partly mesh the external toothed gear with the internally toothed gear, where rotation of the wave generator moves meshing positions of the gears in a circumferential direction causing the inner ring to rotate in relation to the outer ring. In the illustrated embodiment a part of the inner ring extends out of the outer ring and constitutes an outwardly protruding output flange. The output flange and strain wave gear can for instance be provided as the strain wave gear disclosed in WO 2019/096923 and/or as described in the Danish patent application DK PA 2021 70142, the European patent application EP 21216445.3, the U.S. patent application Ser. No. 17/553,110 and the Chinese patent application CN 202210042102.4. However, it is to be understood that the strain wave gear can be provided as any kind of strain wave gears e.g. as disclosed in U.S. Pat. Nos. 5,906,142; 5,775,178; 8,991,282 or alternatively as another kind of gear unit e.g. solar/planet gears or circular wave gears.

A motor is arranged in the housing of the robot element 521, at the motor comprises motor axel 541, a magnetic motor rotor 543 mounted on the motor axel and a motor stator 544 configured to rotate the motor rotor and motor axel. The motor axel is configured to rotate the wave generator 559 and the output flange 540 will thus be rotated upon rotation of the motor axel. The motor is controlled by a motor control circuit 560, as known in the art of motor control.

The two robot elements are interconnected by clamping the connection flange 522 and the output flange 540 by a pair of clamps 524. The connection flange and output flange comprise a plurality of mating teeth and cavities and the clamps are provided as V-clamps as described in WO 2018/130447 A1. An outer seal ring 561 is also provided around the clamps in order to prevent moist and dirt from entering the interior of the robot element through small openings between the two robot elements.

In FIG. 5B arrows A1, A2, A3, A4a, A4b illustrates various method steps of a method of providing a robot element. The method comprises:
a step of providing (not showing by an arrow) a robot element comprising a connecting flange 522 having a central axis 526;
a step (illustrated by arrow A1) of arranging the annular light source array 528 around the central axis such that the plurality of light sources emit light in a direction along the central axis by passing the light source array over the connecting flange, such that the connecting flange passes through an opening of the light source array. In the illustrated embodiment the light source array is thereby arrange in the annual mounting recess 552;
a step (illustrated by arrow A2) of arranging the optical component 532 above the light source array 528, such that the optical component direct at least a part of emitted light in a direction away from the central axis by, passing the annular optical component over the connecting flange 522, such that the connecting flange passes through a central opening of the annular optical component;
a step of connecting (illustrated by arrow A3) the connecting flange 522 with the output flange 540 by moving the robot elements in relation to each other such that the connecting flange and output flange aligns and get in contact with each other.
a step of clamping the connecting flange and the output flange 540 by mounting (illustrated by arrows A4a and A4b) a pair of clamps to the connecting flange and the output flange. The illustrated clamps are interconnected by a clamping screw 527. Alternatively, the clamps can also be interconnected by using quick release mechanisms.

FIGS. 6A-6K illustrate the robot element 520 of the two interconnected robot elements 520, 521 illustrated in FIGS. 5A and 5B. FIG. 6A is a perspective view of the robot element; FIG. 6B is an enlarged view of detail D of FIG. 6A; FIG. 6K is an enlarged view of detail G of FIG. 6K; FIG. 6C is an exploded perspective view of the robot element, FIG. 6D illustrates detail E of FIG. 6C, FIG. 6E illustrates detail F of FIG. 6C; FIG. 6G is a top view of the robot element; FIG. 6F is a cut-away along line A-A of FIG. 6G; FIG. 6H is a cross-sectional view illustrating only the elements along line A-A of FIG. 6G; FIG. 6I is a cross-sectional view illustrating only the elements along line B-B of FIG. 6G; FIG. 6J is a cross-sectional view illustrating only the elements along line C-C of FIG. 6G. The robot elements 520 is identical with the robot element 520 illustrated in FIGS. 5A and 5B and identical features have been given the same reference numbers as in FIGS. 5A and 5B and with not be described further.

The annular optical component 532 comprises at least one resilient snap element 633A, 633B configured to snap engage with an engagement edge 662 of the robot element. In the illustrated embodiment five snap elements are extending inwardly from the inner circumference of the annular optical element and provided as resilient hooks where three hooks 633A are identical and two hooks 633B are identical. The resilient hooks are separated by approximately 90 degrees around the annular optical angle and the two resilient hooks 633B constitute a hook pair arranged nearly side by side. The engagement edge is provided as an annual groove provided below the connecting flange, however, it is to be understood that the engagement edge also can be provided as an outwardly extending flange. The engagement edge can also be provided as individual grooves, recess and/or protrusion of the robot element. Also, it is to be understood that the at least one resilient snap element can extend outwardly from the annular optical element and engage an engagement edge with an outer part of the robot element for instance a groove provided at the outer wall of the recess 552. Providing the optical component with snap elements configured to engage an engagement of the robot element makes it easy and fast to arrange the optical component above the light source array.

The optical component comprises an inner annular optical element 635 and an outer annular optical element 636 where, as illustrated in FIG. 6J, the inner annular optical element is configured to direct a first part 615 of the emitted light in to a second part 616 of light propagating in a direction away from the central axis of the robot element. Before leaving the robot element the second part of the light is diffused 617 in many directions by the second annular optical element 636.

In the illustrated embodiment the inner annular optical element is connected to the outer annular optical element via connecting elements 638 provided at different positions between the inner annular optical element and the outer annular optical element. Also, it can be seen, that the snap elements 633A, 633B are protruding from the outer annular optical element and arranged in openings provided in the inner annular optical element. The optical component is provided as a single piece component for instance molded in an optical transparent material such as glass, polymers, silicone, acrylic materials.

However it is to be understood that the person skilled in that can provide the elements of the optical component as separate elements which can be and arranged in the robot element.

In one embodiment the inner optical element can be configured to diffuse and direct light in many directions away from the central axis. Consequently, the light directed away from the central axis with hit the second annular optical element at many positions, which provides a more uniform illumination of the second annular optical element whereby the optical element appears even more uniform illuminated.

The outer circumferential cross section dimension of the outer annular optical element is the same as the cross-sectional dimension of the robot element. Consequently, the diameter of the outer annular optical element and the robot element is the same. Also, the cross-sectional dimension of the clamps 524A, 524B with the outer seal ring 561 arranged around the clamps are the same as the cross-sectional dimension of the outer annular optical element. An illuminating circular surface can hereby be seamless integrated into the connection between two robot elements.

Additionally, the optical component comprises a pressure element configured to provide a pressing force to the light source array when the optical component is arranged above the light source array. The pressure element can hereby ensure that the light source array is presses against the mounting surface. In the illustrated embodiment the pressure element is provided as a resilient finger 634 extending downwards from the optical component. As illustrated in FIG. 6H the resilient finger will upon mounting of the optical component push the light source array 228 against at least one resilient electrical contact 648 forming part of the light source control PCB 549. The light source array comprises at least one electrical contact pad which can establish an electrical connection between the resilient electrical contact when the two are pushed against each other. The light source array can hereby be electrical connected with the light source control PCB 549 and the pressure element provides a pressing force which ensures a stable electrical connection. Consequently, the light source array will automatically be connected to the light source control PCB upon mounting of the light source array in the recess and the mounting of the annular optical component onto the robot element.

An o-ring 637 is also provided between the optical component and the robot element.

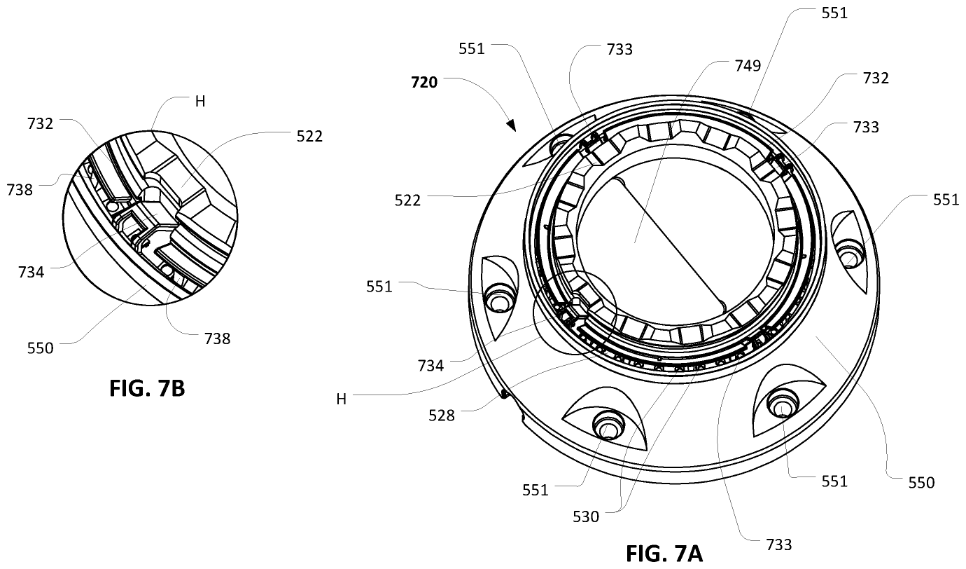

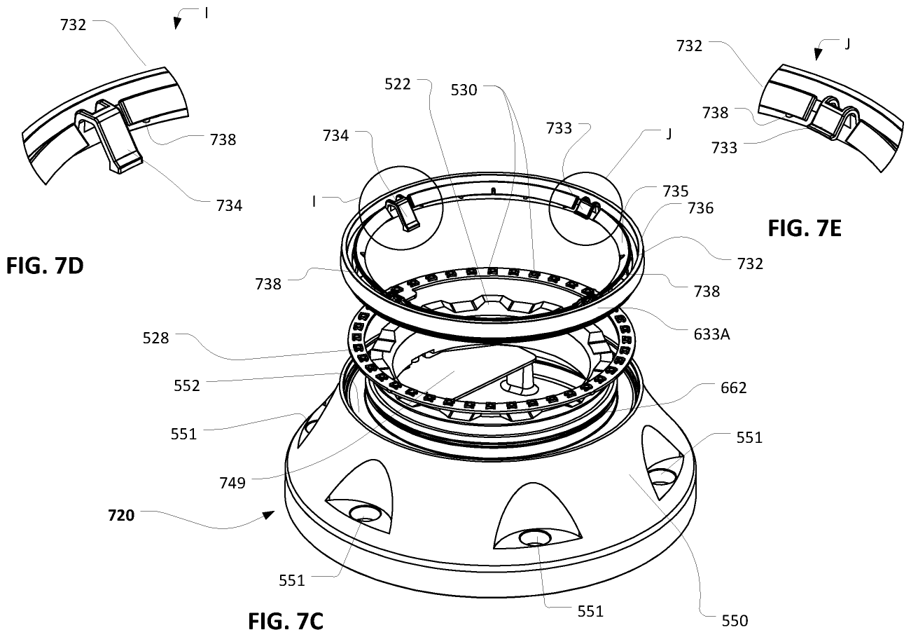

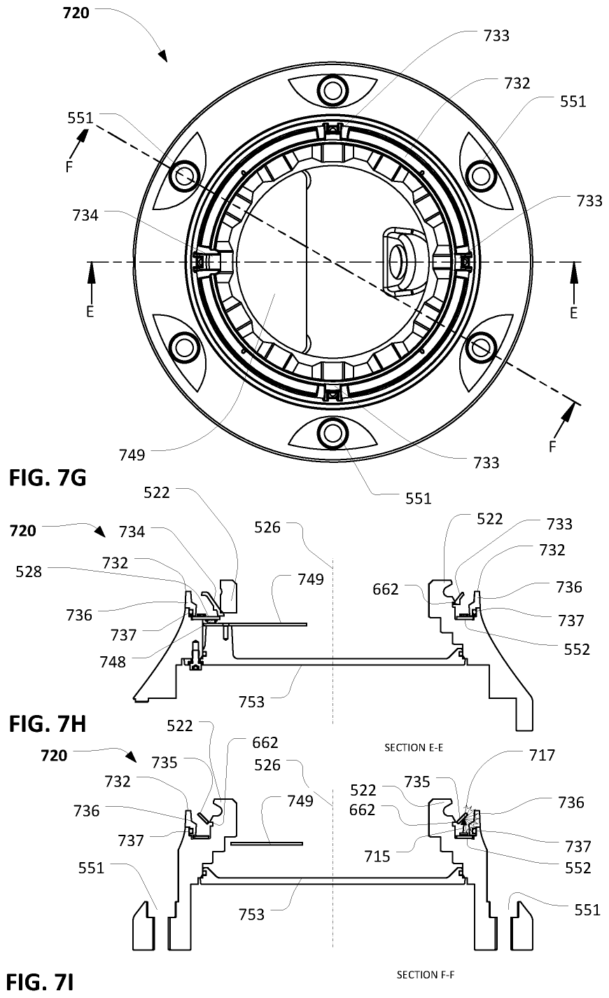

FIGS. 7A-7E and 7G-7I illustrate a robot element 720 similar to the robot element 520 illustrated in FIGS. 5A and 5B, where FIG. 7A is a perspective view of the robot element; FIG. 7B is an enlarged view of detail H of FIG. 7A; FIG. 7C is an exploded perspective view of the robot element, FIG. 7D illustrates detail I of FIG. 7C, FIG. 7E illustrates detail J of FIG. 7C; FIG. 7G is a top view of the robot element; FIG. 7H is a cross-sectional view illustrating only the elements along line E-E of FIG. 7G; FIG. 7I is a cross-sectional view illustrating only the elements along line F-F of FIG. 7G; The robot element 720 is similar to the robot element 520 illustrated in FIGS. 5A-5B and FIGS. 6A-6K and identical features have been given the same reference numbers as in FIGS. 5A-5B and FIGS. 6A-6K and will not be described further.

The annular optical component 732 comprises three snap element 733 configured to snap engage with an engagement edge 662 of the robot element. In the illustrated embodiment the three snap elements are extending inwardly from the inner circumference of the annular optical element and are provided as resilient hooks engaging the engagement edge. A pressure element 734 is configured to provide a pressing force to the light source array 528 when the optical component is arranged above the light source array. The pressure element can hereby ensure that the light source array is pressed against the mounting surface. In the illustrated embodiment the pressure element 734 extends downwards from the optical component and wedge into an opening between the output flange and the light source array (see left side of FIG. 7H), whereby the lower surface of the pressure element 734 push the light source array 528 against at least one resilient electrical contact 748 forming part of the light source control PCB 749. The light source array comprises at least one electrical contact pad which can establish an electrical connection between the resilient electrical contact when the two are pushed against each other. The light source array can hereby be electrical connected with the light source control PCB 749 and the pressure element provides a pressing force which ensures a stable electrical connection. Consequently, the light source array will automatically be connected to the light source control PCB upon mounting of the light source array in the recess and the mounting of the annular optical component onto the robot element.

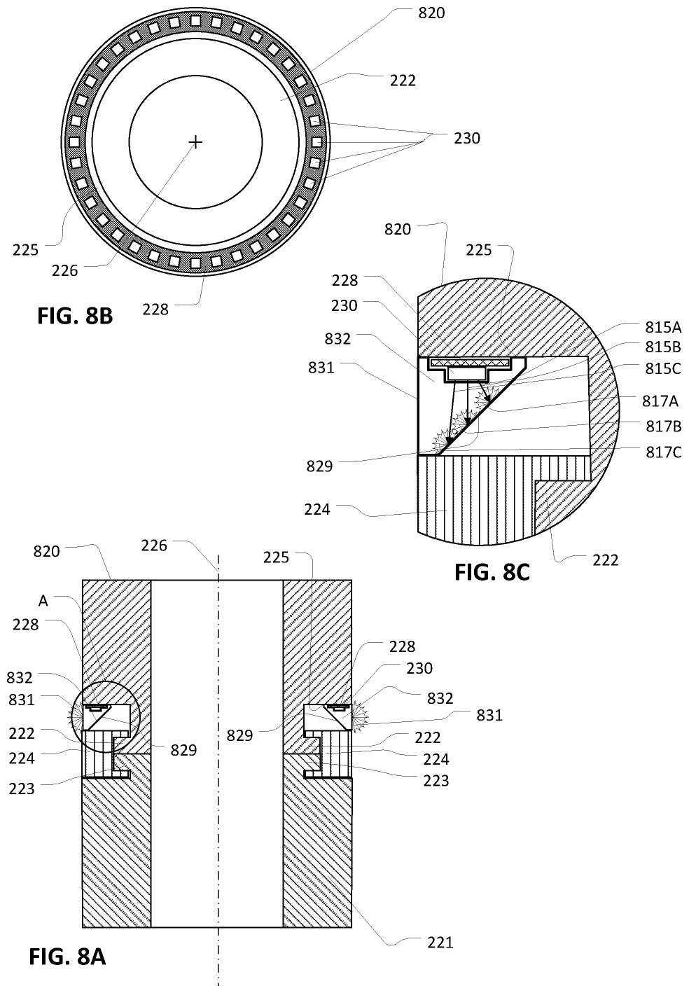

The optical component 732 comprises an inner annular optical element 735 and an outer annular optical element 736. The inner annual optical element is, as illustrated in FIG. 7I (right side), configured to diffuse at least a part of the light 715 propagating in a direction along the central axis in many directions 717 away from the central axis. Consequently, the light directed away from the central axis with hit the second annular optical element at many positions, which provides a more uniform illumination of the second annular optical element, whereby the illumination of the optical element appears even more uniform. This principle is further described in connection with FIGS. 8A-8C.

FIGS. 8A-8C illustrate two interconnected robot elements 820, 221 of a robot arm, where one of the robot elements 820 is provided as an embodiment of the robot element according to the present invention, and where the least one optical component 832 is configured to diffuse at least a part of the light propagating in a direction along the central axis in many directions away from said central axis. FIG. 8A is a structural cross-sectional view of the two interconnected robot elements 820, 221, FIG. 8B is a top view of the robot element 820 with the optical component 832 removed and FIG. 8C is an enlarged view of part B of FIG. 8A. The illustrated interconnected robot elements 820,221 are to a large extend identical with the interconnected robot elements 220,221 illustrated in FIGS. 2A-2C and identical features have been given the same reference numbers as in FIGS. 2A-2C and with not be described further.

In the illustrated embodiment, the optical component 832 is provided as a solid transparent annular ring having an input surface facing towards the light source, a diffusing element 829, and an output surface 831.

The diffusing element 829 is configured to diffuse at least a part of the light propagating along the central axis in many directions away from the central axis and towards an output surface 831. FIG. 8C illustrates three exemplary light rays, where the light rays 815A, 815B, 815C are diffused by the diffusing element 829 at least partially in a direction away from the optical axis as illustrated by arrows 817A, 817B and 817C respectively (only illustrated in FIG. 8C for simplicity of FIG. 8A). The light diffused away from the optical axis will exit the optical component via the output surface 831 and be emitted as diffused light 817 (only illustrated in FIG. 8A for simplicity of FIG. 8). This makes it possible to observe the illumination from many directions and does also provide an uniform illumination of the optical component. It is noted that the light rays are provided only to illustrate the principles of the invention and that they do not illustrate exact and precise light rays.

The transparent optical component can be provided in any optical transparent material such as glass, polymers, silicone, acrylic materials. In the illustrated embodiment the diffusing element is provided as a reflecting diffusing surface which reflects and diffuses the light in many directions away from the optical axis. The reflecting diffusing surface can for instance be provided as an optical surface which has been given diffusing properties that scatters the light in many directions away from the central optical axis as known in the art of optics, for instance by sandblasting, molding or the like, such that the surface has a rough structure stat scatters the light. The diffusing surface can also be treated with a reflecting coating which whereby more of the diffused light can be reflected in a direction away from the central axis. Also, the optical component can be provided in a material with scattering properties where the light is scattered inside the material. The optical component can also be provided as a plurality of optical components receiving light propagating in a direction along the central axis from one or more of the light sources and diffusing the received light in a direction away from the optical axis.

The optical component can also comprise a diffusing element configured to diffuse the light propagating in a direction away from the central axis in many directions away from the central axis. In the illustrated embodiment the optical diffusing element is provided at the output surface of the optical component 832 and the diffused light 817A, 817B and 817C that propagates away from the optical axis and that hits the diffusing element at the output surface is also diffused in many directions 817 (FIG. 8A). This enhances the diffusing effect and make the illumination surface appear more homogeneous illuminated.

In one embodiment the inner dimension of the annular optical component is larger than the cross-section dimension of the connecting flange.

This makes it possible to mount the annular optical component onto the robot element in a single step for instance by passing the optical component over the connecting flange, such that the connecting flange passes through an opening of the optical component. The optical component can then be mounted on top of the light source array for instance by glue, screws, rivets, nails, snap mechanism, or other kind of fastening mechanisms. The optical component can thereby be mounted below the connecting flange.

In one embodiment the outer dimension of the annular optical component is substantially the same as the outer cross-sectional dimension of the robot element. In the illustrated embodiment this is achieved by providing the output surface of the optical component with the same diameter as the robot element.

It is noted that the principles of diffusing at least a part of the light propagating in a direction along the central axis in many directions away from the central axis also can be utilized in the other embodiments described and illustrated in the present invention. For instance, by: replacing the optical component 232 in FIGS. 3A-3C and 4A-3C with the optical component 832 of FIGS. 8A-8C; by modifying the reflecting surface of the optical component 232 in FIGS. 2A-2C, 3A-3C and 4A-4c to also have diffusing properties, providing diffusing properties to the inner annular optical elements 635 of FIGS. 6A-6K or 735 of FIG. 7A-7E and 7G-7I.

The present invention is beneficial in connection with robot arms comprising a plurality of interconnected robot elements as it makes is possible to provide indicating light that is integrated into the robot arm in a seamless and aesthetic way. It is noted that the robot elements may comprise a plurality of output flanges rotatable and/or translatable by joint actuators, for instance one of the robot elements may comprise a first output flange rotating/translating a first part of the robot arm in relation to the robot element and a second output flange rotating/translating a second part of the robot arm in relation to the robot element.

BRIEF DESCRIPTION OF FIGUR REFERNCES

| | |
|---|---|
| 100 | robot system |
| 101 | robot arm |
| 102a-102f | robot joint |
| 103 | robot base |
| 104 | robot tool flange |
| 105a-105f | robot joints axis |
| 110 | robot controller |
| 111 | interface device |
| 112 | display |
| 113 | input devices |
| 215A, 215B, 215C, 615, | first part of light ray |
| 715, 815A, 815B, 815C | |
| 216A, 216b, 216C, 616 | second part of light ray |
| 217, 617, 717, 817, | diffused light |
| 817A, 817B, 817C | |
| 220, 420, 520, 720, 820 | robot element |
| 221, 321, 521 | another robot element |
| 222, 522 | connecting flange |
| 223, | another connecting flange |
| 224, 524, 524A, 524B | connecting clamp |
| 225 | mounting flange |
| 226, 526 | Central axis |
| 527 | clamping screw |
| 228, 558 | light source array |
| 229, 829 | diffusing element |
| 230, 530 | light source |
| 232, 532, 732, 832 | optical component |
| 633A, 633B, 733 | snap mechanism optical component |
| 634, 734 | pressure element |
| 635, 735 | inner annular optical element |
| 636, 736 | outer annular optical element |
| 637, 737 | O-ring |
| 638, 738 | connecting element |
| 340, 440, 540 | output flange |
| 341, 441, 541 | motor |
| 342, 442, 542 | motor axel |
| 543 | motor rotor |
| 544 | motor stator |
| 648, 748 | resilient electrical contacts |
| 549, 749 | light source control PCB |
| 550 | conical housing |
| 551 | screw holes |
| 552 | annular recess |
| 553, 753 | bottom cover |
| 554 | angled connection flange |
| 555 | inner ring of strain wave gear |
| 556 | outer ring of strain wave gear |
| 557 | internally toothed gear of strain wave gear |
| 558 | flex spline of strain wave gear |
| 559 | wave generator |
| 560 | motor control circuit |
| 561 | outer seal ring |
| 662 | engagement edge |
| A1 | step of arranging light source array |
| A2 | step of arranging the optical component |
| A3 | step of connecting robot elements |
| A4a, A4b | step of clamping flanges |

1. An element for a robotic arm, the element comprising:
a connecting flange having a central axis, the connecting flange being configured to connect the element to at least one additional element;
an annular light source array comprising a plurality of light sources around the central axis, wherein the plurality of light sources are configured to emit light in a direction along the central axis; and
at least one optical component above the annular light source array and configured to direct at least a first part or a second part of the light in a direction away from the central axis.

2. The element of claim 1, wherein an inner dimension of the annular light source array is larger than a cross-sectional dimension of the connecting flange.

3. The element of claim 2, wherein the at least one optical component comprises a diffusing element configured to diffuse light propagating in the direction away from the central axis in a plurality of directions away from the central axis.

4. The element of claim 3, wherein the diffusing element is a part of an outer surface of the optical component.

5. The robot element of claim 2, wherein the diffusing element is configured to diffuse at least one of a first part or a second part of the light in the plurality of directions away from the central axis toward an output surface to be emitted as diffused light

6. The element of claim 1, wherein the at least one optical component comprises an annular optical component around the central axis.

7. The element of claim 6, wherein the annular optical component comprises an inner annular optical element and an outer annular optical element, and
wherein the inner annular optical element is configured to direct the first part of the light towards the outer annular optical element.

8. The element of claim 7, wherein the outer annular optical component comprises a diffusing element configured to diffuse the first part of the light.

9. The element of claim 7, wherein the inner annular optical component comprises a diffusing element configured to diffuse the second part of the light towards the outer annular optical component.

10. The element of claim 7, wherein the an inner dimension of the annular optical component is larger than a cross-sectional dimension of the connecting flange.

11. The element of claim 7, wherein an outer dimension of the annular optical component is substantially the same as an outer cross-sectional dimension of the element.

12. The element of claim 1, wherein the connection flange is configured to interconnect with an output flange of at least one additional element of the robotic arm;
wherein the at least one additional element comprises a motor; and
wherein the motor comprise a motor axle that is rotatable around the central axis and that is connected to the output flange.

13. The element of claim 1, further comprising:
a motor comprising a motor axle that is rotatable around the central axis, wherein the connecting flange is an output flange connected to the motor axle and connected to an additional connecting flange of at least one additional element of the robotic arm.

14. The element of claim 1, wherein the annular light source array is in an annular recess surrounding the central axis.

15. The element of claim 1, wherein the at least one optical component comprises at least one resilient snap element configured to snap-fit with an engagement edge of the element.

16. The element of claim 1, wherein the at least one optical component comprises at least one resilient force element configured to apply a force to the annular light source array.

17. The element of claim 1, wherein the annular light source array comprises an annular printed circuit board comprising a plurality of light sources.

18. The element of claim 1, wherein the element is a base configured to support the robotic arm, the robotic arm comprising a plurality of elements connecting the base with a tool flange.

19. The element of claim 1, wherein the element is a joint of the robotic arm, the robotic arm comprising a plurality of elements connecting a base of the robotic arm with the tool flange

20. The element 19 of claim 1 wherein the annular light source array comprises at least 12 light sources.

21. A robotic arm comprising a plurality of joints connecting a base with a tool flange, wherein at least one of the base and a joint among the joints comprises the element of claim 1.

22. A method of building an a element of a robotic arm, the element comprising a connecting flange having a central axis, the method comprising:
arranging an annular light source array comprising a plurality of light sources around the central axis such that the plurality of light sources emit light in a direction along the central axis; and
arranging at least one optical component above the annular light source array such that the at least one optical component directs at least a first part or a second part of the light in a direction away from the central axis.

23. The method of claim 22, wherein arranging the annular light source array around the central axis comprises mounting the annular light source array onto a mounting surface of the element by passing the annular light source array over the connecting flange, such that the connecting flange passes through an opening of the annular light source array.

24. The method of claim 22, wherein the at least one optical component comprises an annular optical component, and wherein mounting the at least one optical component comprises passing the annular optical component over the connecting flange, such that the connecting flange passes through the opening of the annular optical component.

25. The method of claim 22, further comprising connecting the connecting flange to an additional connecting flange of at least one additional robotic element which comprises the additional connecting flange.

26. The method of claim 25, wherein connecting the connecting flange to the additional connecting flange comprises mounting a clamp to the connecting flange and the additional connecting flange.
